(19) United States
(12) Patent Application Publication
(10) Pub. No.: US 2023/0262199 A1
(43) Pub. Date: Aug. 17, 2023

(54) MEETING MANAGEMENT APPARATUS, MEETING MANAGEMENT METHOD AND NON-TRANSITORY COMPUTER-READABLE MEDIUM

(71) Applicant: V-CUBE, INC., Tokyo (JP)

(72) Inventors: Yosuke KAMEZAKI, Tokyo (JP); Hironori NURISHI, Tokyo (JP); Ei SOU, Tokyo (JP); Ken KOSEKI, Tokyo (JP)

(21) Appl. No.: 18/302,791

(22) Filed: Apr. 19, 2023

Related U.S. Application Data
(63) Continuation of application No. PCT/JP2021/030377, filed on Aug. 19, 2021.

(30) Foreign Application Priority Data
Nov. 4, 2020 (JP) 2020-184302

(51) Int. Cl. H04N 7/15

(52) U.S. Cl. CPC H04N 7/152; H04N 7/155

(57) ABSTRACT

A meeting management apparatus manages a plurality of group meetings that a plurality of users can attend using a communication terminal, and includes a data acquiring part that acquires user data concerning a plurality of users before the start of an event including the plurality of group meetings, a pattern determining part that determines a pattern in which each of the plurality of users and any one of the plurality of group meetings are associated with each other on the basis of the user data, and a terminal control part that causes each of the plurality of users to attend the group meeting associated with the user in the pattern among the plurality of group meetings after the start of the event.

### CROSS-REFERENCE TO RELATED APPLICATIONS

The present application is a continuation application of International Application number PCT/JP2021/30377, filed on Aug. 19, 2021, which claims priority under 35 U.S.C § 119(a) to Japanese Patent Application No. 2020-184302, filed on Nov. 4, 2020. The contents of this application are incorporated herein by reference in their entirety.

### BACKGROUND OF THE INVENTION

The present disclosure relates to a meeting management apparatus, a meeting management method, and a computer-readable non-transitory storage medium for managing meetings performed via a network.

There is known a technique for performing a meeting by transmitting and receiving audio signals via a network. Japanese Unexamined Patent Application Publication No. 2020-144476 discloses a meeting system that enables the performance of a plurality of group meetings.

### BRIEF SUMMARY OF THE INVENTION

In an event that includes a plurality of group meetings, a host may specify attendees who attend each group meeting. In such a case, there is a problem since an operation of allocating each of a plurality of attendees to one of the plurality of group meetings is a labor-intensive and time-consuming task for the host.

The present disclosure focuses on this point and its object is to reduce the time and effort needed to specify a plurality of attendees attending each of a plurality of group meetings.

A meeting management apparatus according to a first aspect of the present disclosure is a meeting management apparatus managing a plurality of group meetings that a plurality of users can attend using a communication terminal, the meeting management apparatus including: a data acquiring part that acquires user data concerning the plurality of users before the start of an event including the plurality of group meetings; a pattern determining part that determines a pattern in which each of the plurality of users and any one of the plurality of group meetings are associated with each other on the basis of the user data; and a terminal control part that, after the start of the event, causes each of the plurality of users to attend the group meeting associated with the user in the pattern among the plurality of group meetings.

A meeting management method according to a second aspect of the present disclosure is a meeting management method, executed by a computer, for managing a plurality of group meetings that a plurality of users can attend using a communication terminal; the meeting management method including: acquiring user data concerning the plurality of users before the start of an event including the plurality of group meetings; determining a pattern in which each of the plurality of users and any one of the plurality of group meetings are associated with each other on the basis of the user data; and causing each of the plurality of users to attend the group meeting associated with the user in the pattern among the plurality of group meetings after the start of the event.

A storage medium according to a third aspect of the present disclosure is a computer-readable non-transitory storage medium storing a program for causing a computer to manage a plurality of group meetings that a plurality of users can attend using a communication terminal; the program causing the computer to execute: acquiring user data concerning the plurality of users before the start of an event including the plurality of group meetings; determining a pattern in which each of the plurality of users and any one of the plurality of group meetings are associated with each other on the basis of the user data; and causing each of the plurality of users to attend the group meeting associated with the user in the pattern among the plurality of group meetings after the start of the event.

### BRIEF DESCRIPTION OF THE DRAWINGS

FIG. 1 shows a configuration of a meeting management system.

FIG. 2 shows an example of a screen for selecting a group meeting that an attendee will attend.

FIG. 3 shows an example of a screen in the group meeting.

FIG. 4 shows configurations of a meeting management apparatus and an attendee terminal.

FIG. 5A shows an example of an event information setup screen displayed on a host terminal.

FIG. 5B shows an example of a profile item setup screen displayed on the host terminal.

FIG. 6 shows an example of a table setup screen displayed on the host terminal.

FIG. 7A shows an example of a user setup screen displayed on the host terminal.

FIG. 7B shows an example of a user setup screen displayed on the host terminal.

FIG. 8A shows an example of exemplary first user data.

FIG. 8B shows an example of exemplary second user data.

FIG. 9 shows an example of an event status screen displayed on the host terminal.

FIG. 10 shows an example of a screen in the group meeting displayed on an exhibitor terminal.

FIG. 11A shows an example of a screen related to shifting of a user displayed on the host terminal.

FIG. 11B shows an example of a screen related to shifting of a user displayed on the attendee terminal or the exhibitor terminal.

FIG. 12 is a flowchart showing an example of a flow of processing in the meeting management apparatus.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### [Outline of a Meeting Management System S]

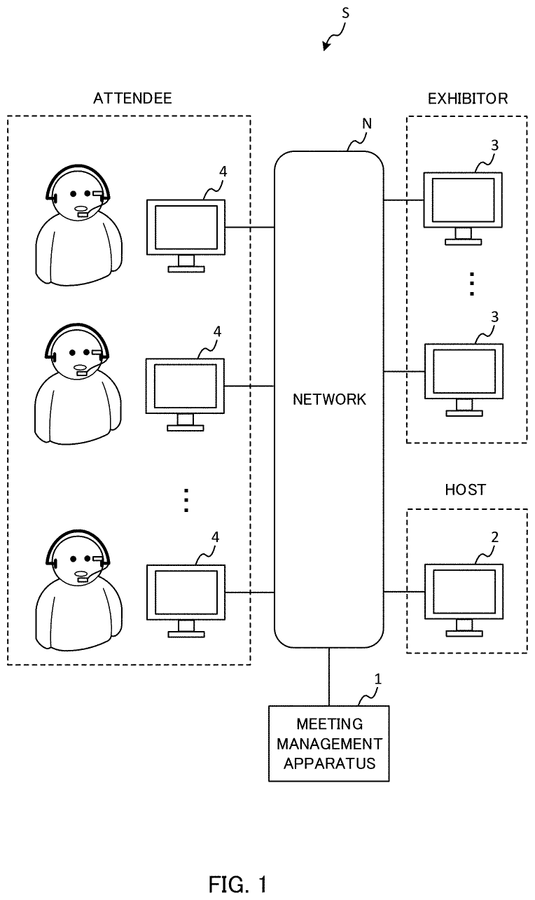

FIG. 1 shows a configuration of a meeting management system S. The meeting management system S is a system for enabling a plurality of group meetings to be performed online in parallel. The meeting management system S is suitable for an event where a plurality of attendees who are seeking jobs interact with people in charge of a plurality of exhibitor companies who are recruiting new employees, or an online event where people in charge of a plurality of exhibitor companies who wish to introduce their products or services and a plurality of attendees who wish to obtain information concerning products or services can exchange information, for example. The application of the meeting management system S is not limited to the event described above.

In the example shown in FIG. 1, the meeting management system S includes a meeting management apparatus 1, a host terminal 2, a plurality of exhibitor terminals 3, and a plurality of attendee terminals 4. The meeting management apparatus 1 is a device for managing a plurality of group meetings that a plurality of attendees can attend using communication terminals. The meeting management apparatus 1 is a server that executes data processing for realizing a plurality of group meetings, and is managed by organizers (e.g., hosts of an event) of the plurality of group meetings, for example.

The meeting management apparatus 1 causes the plurality of exhibitor terminals 3 and the plurality of attendee terminals 4 to display a screen for attending the plurality of group meetings via a network N so that a plurality of people can attend the plurality of group meetings. The meeting management apparatus 1 provides an exhibitor terminal 3 and an attendee terminal 4 registered in advance with a web application, thereby allowing the exhibitor terminal 3 and the attendee terminal 4 to attend the group meeting. Details of the meeting management apparatus 1 will be described later.

The host terminal 2 is a communication terminal used by the organizers of an event including the plurality of group meetings, and is, for example, a computer. An organizer performs various initial settings for an event including the plurality of group meetings. For example, the organizer sets the number of people who can attend each group meeting, and sets the size of a booth (also referred to as a table) corresponding to each group meeting in a layout diagram (map) of an event venue to be displayed on the plurality of exhibitor terminals 3 and the plurality of attendee terminals 4, via the host terminal 2.

The exhibitor terminal 3 is a communication terminal used by a person in charge of an exhibitor company that is to attend a group meeting (hereinafter referred to as “person in charge,”) and is, for example, a computer, a tablet, or a smartphone. The exhibitor terminal 3 is disposed in an office of the exhibitor company, and is operated by one or more people in charge of the exhibitor company to transmit and receive various types of data to and from the attendee terminal 4 via the meeting management apparatus 1. The exhibitor terminal 3 transmits, to the meeting management apparatus 1, image data for a presentation, audio data of the person in charge, and text data input by the person in charge, for example. In an event in which a group meeting is held between only a plurality of attendee terminals 4, the meeting management system S need not include the exhibitor terminal 3.

The attendee terminal 4 is a communication terminal used by a visitor to an event who will attend a group meeting (hereinafter referred to as an “attendee”), and is, for example, a computer, a tablet, or a smartphone. The attendee terminal 4 is operated by the attendee to transmit and receive various types of data to and from the exhibitor terminal 3 or another attendee terminal 4 via the meeting management apparatus 1. The attendee terminal 4 receives image data, audio data, and text data transmitted from the exhibitor terminal 3 or another attendee terminal 4, and displays the received data on a screen.

The meeting management apparatus 1 generates various types of data for exchanging information between a plurality of people in charge and a plurality of attendees, and displays the generated, various types of data on screens of the exhibitor terminal 3 and the attendee terminal 4. The meeting management apparatus 1 displays an image indicating booths of the plurality of group meetings that can be attended using the plurality of attendee terminals 4 on the screen of the attendee terminal 4, and allows the attendee to select a group meeting that he/she wishes to attend. A group meeting in this embodiment corresponds to a booth in an event venue, and the attendee can attend a group meeting applied for previously or can shift to another group meeting by operating the attendee terminal 4. Further, the person in charge may attend a group meeting by operating an exhibitor terminal 3.

A person in charge using the exhibitor terminal 3 and the attendee using the attendee terminal 4 can communicate with each other by sending and receiving text messages to and from each other using a chat feature or by individually sending and receiving voices. The attendee can send text messages to ask questions while the person in charge of the exhibitor company is giving a presentation in the group meeting, or can have voice conversation with the person in charge individually after the presentation, for example. Further, a plurality of attendees using the attendee terminals 4 can communicate with each other by sending and receiving text messages to and from each other using the chat function or by individually sending and receiving voices.

### Screen Examples

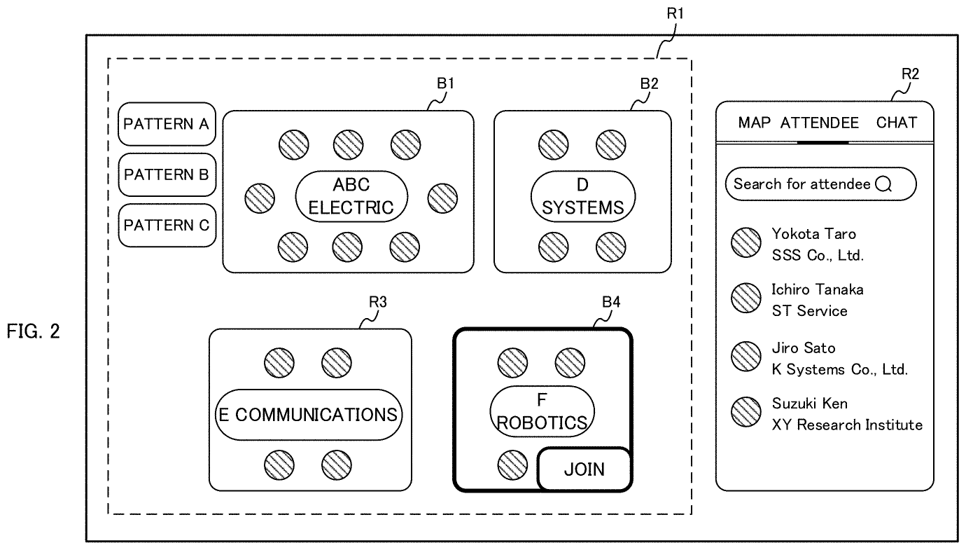

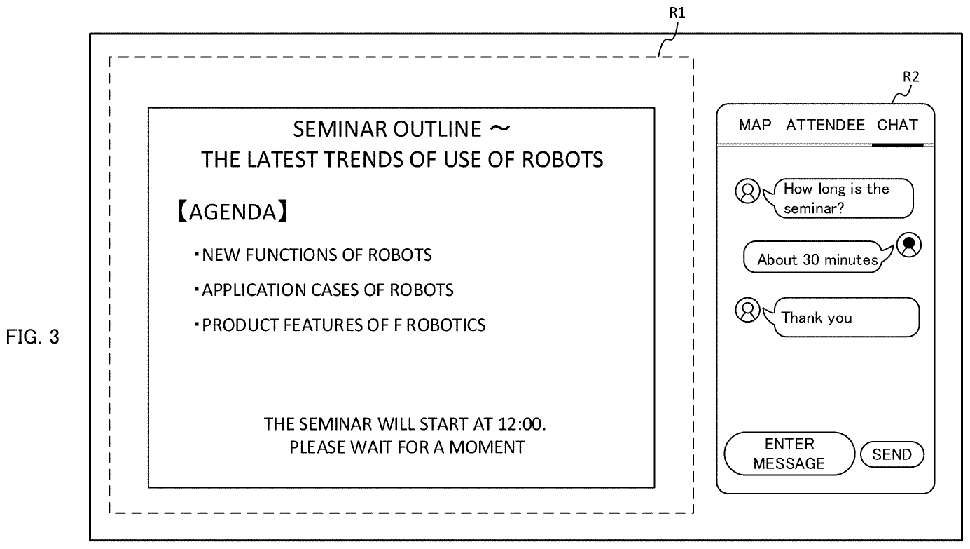

FIGS. 2 and 3 show examples of screens displayed on the attendee terminal 4. FIG. 2 is a screen for selecting a group meeting that the attendee will attend. The names of exhibitor companies organizing group meetings are displayed in an area R1 of FIG. 2, as an outline of the plurality of group meetings. Specifically, the following group meetings are displayed: a group meeting of ABC Electric as a booth B1; a group meeting of D Systems as a booth B2; a group meeting of E Communications as a booth B3; and a group meeting of F Robotics as a booth B4.

An image of a circle with diagonal lines shown in each booth is an icon image corresponding to an attendee. Although the icon image in FIG. 2 is represented by diagonal lines, the icon image may be an image including information for identifying an attendee, such as a face image of the attendee.

The attendee can attend the group meeting corresponding to a selected booth by performing an operation for selecting a booth to attend on the screen of FIG. 2 (e.g., a click operation or a touch operation). FIG. 2 shows a state where the attendee has selected a group meeting of the booth B4.

Various types of information that the attendee can utilize are displayed on an area R2 of FIG. 2. Specifically, in the area R2, a list of attendees at the group meeting that the attendee is attending is displayed, a chat message exchanged with a person in charge is displayed, or a map indicating the layout of the venue is displayed. In FIG. 2, a list of attendees attending the group meeting of the booth B4 is displayed in response to the attendee selecting the group meeting of the booth B4.

If the attendee selects a display area “Join” displayed on the selected booth B4 on the screen shown in FIG. 2, it is determined that the attendee is to attend the group meeting, and the attendee terminal 4 causes a screen in the group meeting to be displayed. FIG. 3 shows an example of a screen in the group meeting. Presentation materials prepared by the exhibitor company are displayed in an area R1 of FIG. 3. A screen for chatting is displayed in an area R2 of FIG. 3. The attendee can send and receive messages to and from a person in charge of the exhibitor company, using a chat screen displayed in the area R2. An operation image for switching whether to or not to send a voice or an image of the attendee may be provided in the area R1 of FIG. 3. In addition, at least one of a captured image of the person in charge captured by a camera of the exhibitor terminal 3 or a captured image of the attendee captured by a camera of the attendee terminal 4 may be displayed in the area R1 of FIG. 3.

The meeting management system S according to the present embodiment is characterized in that a pattern in which each of a plurality of users and any one of a plurality of group meetings are associated with each other is determined in advance by receiving registrations of user data concerning a plurality of users (attendee and person in charge) before the start of an event. The user data is data concerning the plurality of users and is used to determine a pattern for allocating a plurality of users to a plurality of group meetings. The user data is a Comma Separated Value (CSV) file, for example. The pattern is information for allocating the plurality of users to the plurality of group meetings.

For example, the meeting management system S can automatically allocate a plurality of attendees to a plurality of group meetings at the start of an event in accordance with a predetermined pattern, or can easily switch the allocation of the plurality of attendees to the plurality of group meetings in accordance with a pattern selected by the host terminal 2. As a result, the meeting management system S can reduce the time and effort needed for a host of an event to specify attendees attending each of the plurality of group meetings.

### [Outline of the Meeting Management Apparatus 1 and the Attendee Terminal 4]

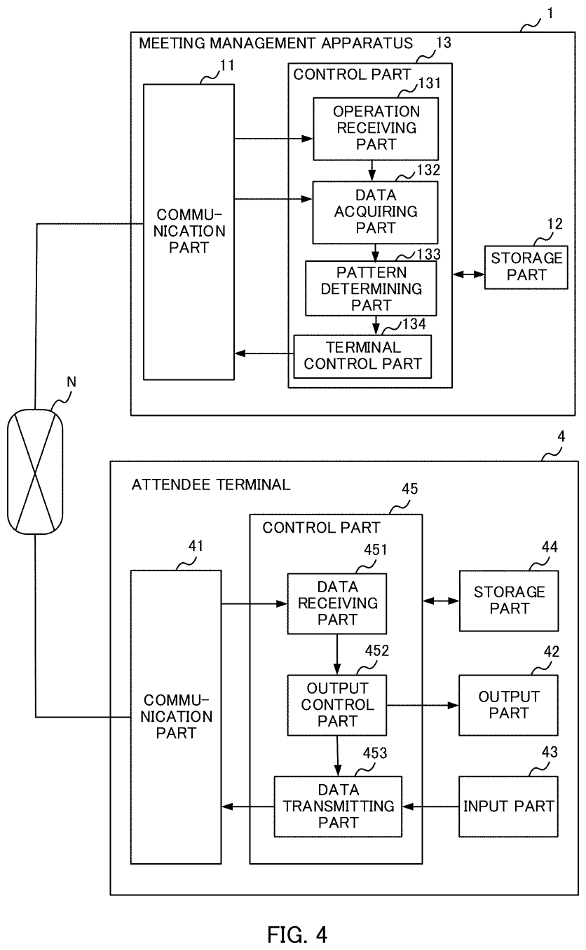

FIG. 4 shows configurations of the meeting management apparatus 1 and the attendee terminal 4. Since the host terminal 2 and the exhibitor terminal 3 have the same configuration as the attendee terminal 4, description thereof will be omitted.

The meeting management apparatus 1 includes a communication part 11, a storage part 12, and a control part 13. The control part 13 includes an operation receiving part 131, a data acquiring part 132, a pattern determining part 133, and a terminal control part 134.

The communication part 11 includes a communication controller for transmitting and receiving various types of data via the network N. The communication part 11 notifies the operation receiving part 131 of data for setting operation received from the host terminal 2, the exhibitor terminal 3, or the attendee terminal 4. The communication part 11 notifies the data acquiring part 132 of user data which will be used in a determination of the pattern received from the host terminal 2. The communication part 11 notifies the data acquiring part 132 of image data or sound data generated in the group meeting. Furthermore, the communication part 11 transmits the image data or sound data input from the terminal control part 134, to the host terminal 2, the exhibitor terminal 3, or the attendee terminal 4.

The storage part 12 includes storage media such as a Read Only Memory (ROM), a Random Access Memory (RAM), and a Solid State Drive (SSD). The storage part 12 stores a program executed by the control part 13. The storage part 12 stores various types of data related to the group meeting. For example, the storage part 12 stores pattern information indicating the pattern in which each of a plurality of users and any one of a plurality of group meetings are associated with each other, which is determined by the control part 13.

The control part 13 includes a Central Processing Unit (CPU), for example. The control part 13 functions as the operation receiving part 131, the data acquiring part 132, the pattern determining part 133, and the terminal control part 134 by executing a program stored in the storage part 12. Details of the operation receiving part 131, the data acquiring part 132, the pattern determining part 133, and the terminal control part 134 will be described later.

The attendee terminal 4 includes a communication part 41, an output part 42, an input part 43, a storage part 44, and a control part 45. The control part 45 includes a data receiving part 451, an output control part 452, and a data transmitting part 453.

Similar to the communication part 11, the communication part 41 includes a communication controller for transmitting and receiving various types of data via the network N. The communication part 41 receives image data and sound data transmitted from the exhibitor terminal 3 via the network N and the meeting management apparatus 1, for example. The communication part 41 inputs the received data to the data receiving part 451. Further, the communication part 41 acquires, from the data transmitting part 453, sound data based on voice input by the attendee using the attendee terminal 4 and text data input by the attendee using the attendee terminal 4, and then transmits the acquired data.

The output part 42 includes a display that functions as a display displaying various types of image data, and a speaker that outputs sound data. In response to an instruction from the output control part 452, the output part 42 displays an image related to the group meeting as shown in FIGS. 2 and 3 on the display, and outputs, to the speaker, sounds generated in the group meeting that the attendee is attending.

The input part 43 is a device that receives an operation made by the attendee using the attendee terminal 4, and is, for example, a keyboard, a mouse, or a touch panel. The input part 43 notifies the data transmitting part 453 of data based on an operation input by the attendee.

The storage part 44 includes storage media such as a ROM, a RAM, and an SSD. The storage part 44 stores a program executed by the control part 13.

The control part 45 includes a CPU, for example. The control part 45 functions as the data receiving part 451, the output control part 452, and the data transmitting part 453 by executing a program stored in the storage part 44.

The data receiving part 451 receives various types of data from the meeting management apparatus 1 via the communication part 41. The data receiving part 451 receives data concerning a plurality of group meetings, for example. The data receiving part 451 inputs the received data to the output control part 452.

The output control part 452 causes the output part 42 to output the data transmitted from the meeting management apparatus 1. The output control part 452 causes an image based on image data to be displayed on the display, and causes a speaker to output a sound based on sound data, for example.

The data transmitting part 453 transmits the data input by the attendee via the input part 43 to the meeting management apparatus 1. The data transmitting part 453 transmits information for identifying the group meeting selected by the attendee to the meeting management apparatus 1, for example.

### [Configuration of the Control Part 13]

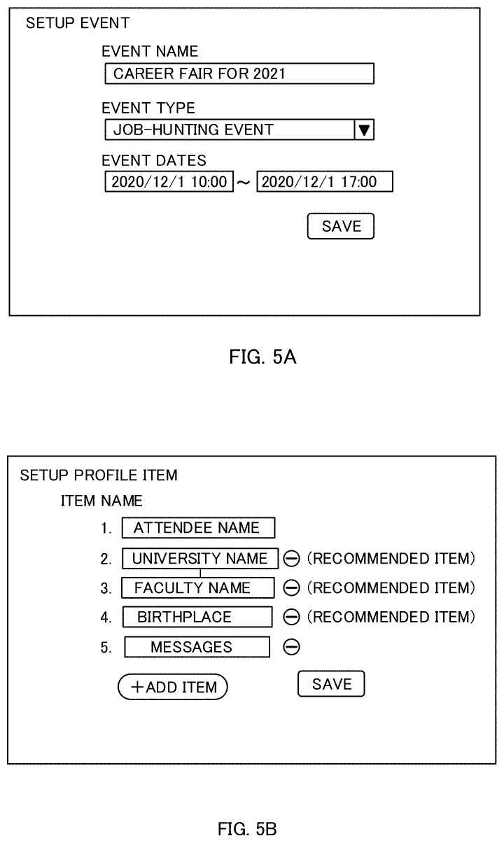

Next, a configuration and operation of the control part 13 will be described in detail. Before the start of an event including a plurality of group meetings, the operation receiving part 131 receives, from the host terminal 2, an operation for making various settings for the event via the communication part 11. The operation receiving part 131 receives, from the host terminal 2 displaying each screen shown in FIGS. 5A, 5B, 6, 7A, and 7B, operations for setting event information, setting items of user attributes, setting a table, and setting users who attend each group meeting, for example. The users include at least one of an attendee or person in charge.

FIG. 5A shows an example of an event information setup screen for setting event information displayed on the host terminal 2. The event information setup screen includes an area for receiving the input of an event name, an event type, and event dates, for example. The event type is a category or purpose of an event, such as a job-hunting event, an exhibition, a business meeting, and the like. The event dates are a period represented by the start date/time and the end date/time of the event. The event information setup screen may receive the input of other information such as an outline of an event.

The operation receiving part 131 receives, as the event information, the information input in the host terminal 2 on which the event information setup screen is displayed. The operation receiving part 131 stores the received event information in the storage part 12.

FIG. 5B shows an example of a profile item setup screen for setting items of user attributes displayed on the host terminal 2. The profile item setup screen includes an area for receiving the input of the items of the user attributes set for each user, for example. The user attributes are information including a user's personal nature (also referred to as a profile), such as (i) his/her name, (ii) the name of a university or organization he/she belongs to, and (iii) birthplace, place of residence, hobby, gender, or age of the user. In addition, the user attributes may include a business category of the organization the user belongs to, and a business category or a job type for which the user desires to find employment. The user attributes may include information indicating a competitive relationship between the organization he/she belongs to and another organization. Further, the user attributes may include membership types indicating whether the user is a paying member who pays to attend the event or a non-paying member who attends the event free of charge. The profile item setup screen may receive the input of other information such as type of data (e.g., selectable option) for each item.

The operation receiving part 131 receives, as the items of the user attributes set for each user, the information input in the host terminal 2 on which the profile item setup screen is displayed. The operation receiving part 131 causes the storage part 12 to store the received information indicating the items of the user attributes.

Here, the operation receiving part 131 may specify an item of the user attributes that should be set according to the event type included in the received event information. The item of the user attributes that should be set is an item which is preferably collected from the user for the event, and is an item that should be included in the user data used for determining a pattern described later.

In this case, information indicating a relationship between the event type and the item of the user attributes that should be set is stored in advance in the storage part 12, for example. For example, when the event type is a “job-hunting event,” the operation receiving part 131 specifies “name of university,” “name of faculty/department,” “birthplace,” and the like as items of the user attributes that should be set. For example, in the case where the event type is “exhibition,” the operation receiving part 131 specifies “organization name,” “job type,” “place of residence,” and the like as items of the user attributes that should be set. The operation receiving part 131 notifies the terminal control part 134 of the specified items of the user attributes that should be set. The terminal control part 134 displays the items of the user attributes that should be set on the profile item setup screen.

As illustrated in FIG. 5B, the terminal control part 134 causes the host terminal 2 to display the profile item setup screen in a state where the items of the user attributes that should be set are input in advance. Further, the terminal control part 134 displays a “recommended item” near the item of the user attributes that should be set. By doing this, the meeting management system S can suggest to the host an item of the user attributes that should be collected from the user according to the type of event, and assist with making settings for the event.

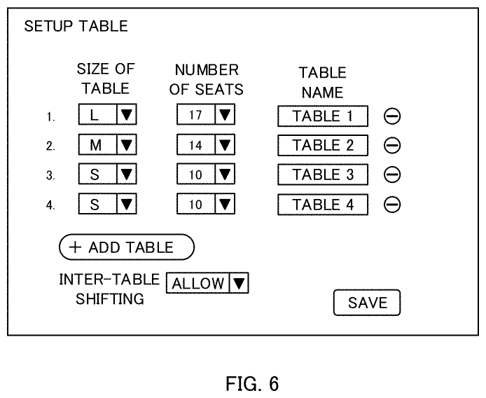

FIG. 6 shows an example of a table setup screen for setting a table displayed on the host terminal 2. The table (i.e., the booth exemplified in the screen in FIG. 2) corresponds to one group meeting. The table setup screen includes an area for receiving input of the size of the table, the number of seats, and the name of the table, for example. The size of the table is the size of a virtual table displayed on the exhibitor terminal 3 or the attendee terminal 4. The number of seats is the maximum number of users who can attend one group meeting. The number of seats may be automatically determined according to the size of the table. The table setup screen may receive input of other information such as an appearance of the table.

Further, the table setup screen may receive a setting of whether or not it is allowable for a user to shift between tables. After the event is started, when it is set to allow the shifting of the user between the tables, the terminal control part 134 shifts the user to the selected table in response to an operation of selecting a destination table in the exhibitor terminal 3 or the attendee terminal 4. On the other hand, when it is set not to allow the shifting of the user between the tables, the terminal control part 134 does not receive the operation of selecting a destination table in the exhibitor terminal 3 or the attendee terminal 4. By doing this, the meeting management system S can switch whether or not to enable inter-table shifting by the user's own will for each event.

The operation receiving part 131 receives, as settings for a table, information input in the host terminal 2 on which the table setup screen is displayed. The operation receiving part 131 stores information indicating the received settings for the table in the storage part 12.

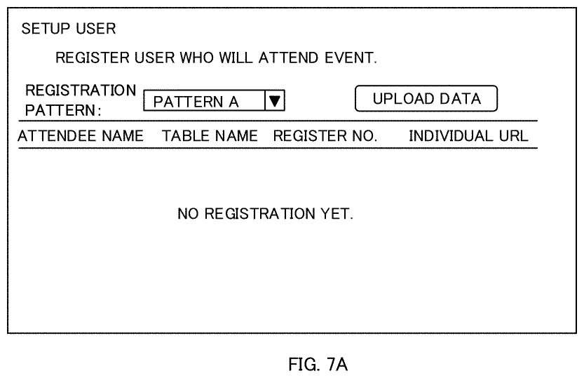

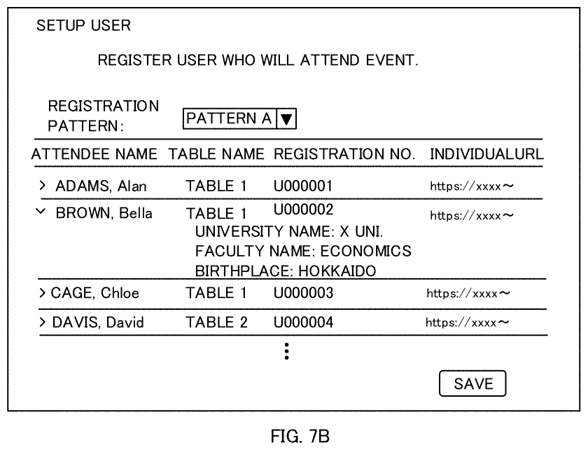

FIGS. 7A and 7B each show an example of a user setup screen displayed on the host terminal 2 for setting users who attend each group meeting. FIG. 7A shows a state before setting the users attending each group meeting, and FIG. 7B shows a state after setting the users attending each group meeting.

In the state of FIG. 7A, the user setup screen includes an upload button for uploading the user data. When the upload button is selected in the host terminal 2 on which the user setup screen is displayed, the operation receiving part 131 receives, from the host, a selection of user data for a plurality of users in the host terminal 2.

The data acquiring part 132 acquires the user data selected by the host terminal 2 via the communication part 11. The user data is the data concerning the plurality of users and is used to determine the pattern for allocating the plurality of users to the plurality of group meetings. The user data is a Comma Separated Value (CSV) file, for example, but may be data of other formats.

The data acquiring part 132 acquires, as the user data, first user data specifying a group meeting which each of the plurality of users attends, or second user data including user attributes of each of the plurality of users. That is, the first user data is data that directly specifies the group meeting which the user attends, whereas the second user data is data that indicates user attributes used for determining the group meeting which the user attends.

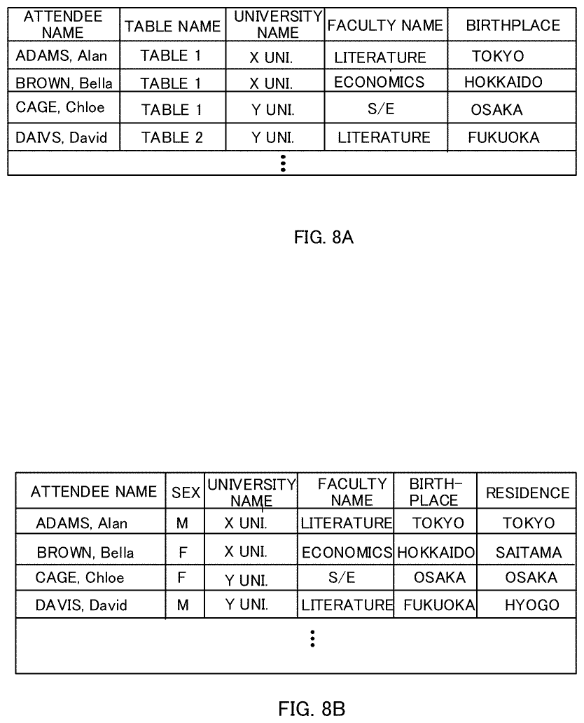

FIG. 8A shows exemplary first user data. In the first user data, the user attributes of the user and the group meeting (“table name” in this case) which said user attends are associated with each other. The user attributes include at least the items set in the profile item setup screen, and include the attendee's name, name of university, name of faculty/department, and birthplace in the example of FIG. 8A.

FIG. 8B shows exemplary second user data. The second user data includes the user attributes of the user. It should be noted that the second user data does not include the group meeting which the user attends. The user attributes include at least the items set in the profile item setup screen, and include the attendee's name, gender, name of university, name of faculty/department, birthplace, and place of residence in the example of FIG. 8B.

The pattern determining part 133 determines a pattern in which each of a plurality of users and any one of a plurality of group meetings are associated with each other on the basis of the user data acquired by the data acquiring part 132. As describe below, the pattern determining part 133 performs different processes for a case where the first user data is used and for a case where the second user data is used.

When the data acquiring part 132 acquires the first user data specifying the group meeting which each of the plurality of users attends, the pattern determining part 133 determines a pattern in which (i) each of the plurality of users and (ii) any one of the plurality of group meetings specified for said user in the first user data are associated with each other. By doing this, the meeting management system S can collectively determine the allocation of the plurality of users to the plurality of group meetings on the basis of the user data, and therefore it is possible to reduce the time and effort of the host to determine a group meeting for each user.

When the data acquiring part 132 acquires the second user data including user attributes of the plurality of users, the pattern determining part 133 determines, among the plurality of group meetings, a group meeting which each of the plurality of users attends on the basis of the user attributes of the plurality of users included in the second user data. In this case, the operation receiving part 131 receives, on the user setup screen, a segmentation setting that indicates whether to divide a plurality of users so that their user attributes are similar or divide the plurality of users so that their user attributes are not similar, for example. The operation receiving part 131 may receive the segmentation setting for each group meeting. The operation receiving part 131 notifies the pattern determining part 133 of the received segmentation setting.

The pattern determining part 133 divides the plurality of users into a plurality of clusters by using a known clustering method, and specifies each of the plurality of clusters as one group meeting so that the user attributes of the plurality of users are similar or not similar according to the segmentation setting performed on the user setup screen. The pattern determining part 133 determines a pattern in which each of the plurality of users is associated with the group meeting corresponding to the cluster to which said user belongs among the plurality of group meetings. That is, the pattern determining part 133 determines a plurality of users attending each of the plurality of group meetings such that at least some of the name of university or organization the users belong to, birthplace, place of residence, hobby, gender, or age of the users, which are included in their user attributes, will be similar or will not be similar. As a result, the meeting management system S can automatically determine the allocation of the plurality of users to the plurality of group meetings on the basis of the user attributes, and therefore it is possible to reduce the time and effort of the host for determining a group meeting for each user.

Further, the pattern determining part 133 may make a determination such that an attendee who is a paying member and an attendee who is a non-paying member attend different group meetings, on the basis of the membership types included in the user attributes. The pattern determining part 133 makes a determination such that the attendee who is a paying member attends a group meeting that requires a fee, and such that the attendee who is a non-paying member attends a free group meeting, for example. By doing this, the meeting management system S can automatically distinguish the paying member and the non-paying member from each other and determine the allocation of the plurality of users to the plurality of group meetings.

For example, when user attributes of a first attendee and user attributes of a second attendee satisfy a predetermined relationship, the pattern determining part 133 may make a specification such that a group meeting which the first attendee attends and a group meeting which the second attendee attends differ among the plurality of group meetings.

The pattern determining part 133 makes a determination such that the first attendee and the second attendee, whose items of predetermined user attributes such as “name of university,” “name of organization,” or the like are the same, attend different group meetings. For example, the pattern determining part 133 makes a determination such that the first attendee and the second attendee who belong to different organizations in a competitive relationship, which are included in the user attributes, attend different group meetings. As a result, the meeting management system S can prevent the attendees whose user attributes satisfy the predetermined relationship from attending one group meeting, and therefore the trends among the user attributes of attendees of a plurality of group meetings can be automatically spread widely.

When the data acquiring part 132 acquires a plurality of pieces of user data, the pattern determining part 133 may determine a plurality of different patterns by determining a pattern on the basis of each of the plurality of pieces of user data. Also, the pattern determining part 133 may determine the plurality of different patterns by applying a plurality of different rules for determining a pattern on the basis of the user attributes to one piece of user data acquired by the data acquiring part 132. The pattern determining part 133 stores pattern information indicating one or a plurality of determined patterns in the storage part 12.

The terminal control part 134 causes the user setup screen to display information concerning the users on the basis of the user data acquired by the data acquiring part 132 and the pattern determined by the pattern determining part 133. In the state shown in FIG. 7B, each of a plurality of users and a group meeting (table name) associated with said user in accordance with the pattern determined by the pattern determining part 133 are displayed on the user setup screen. When the pattern determining part 133 determines a plurality of patterns, each of a plurality of users and a group meeting associated with said user are displayed on the user setup screen in accordance with any one pattern (Pattern A in the example of FIG. 7B) selected by the host terminal 2.

Further, user identification information (registration number in FIG. 7B) for identifying a user automatically assigned to each of a plurality of users and unique access information (individual URL in FIG. 7B) for said user to attend an event may be displayed on the user setup screen. Further, the user attributes of the selected user may be displayed on the user setup screen.

After the start of the event, the terminal control part 134 causes each of the plurality of users to attend the group meeting associated with said user in the pattern determined by the pattern determining part 133 among the plurality of group meetings. The terminal control part 134 executes the group meeting by relaying sound data based on voice input by the user and text data input by the user, which are transmitted from the exhibitor terminal 3 and the attendee terminal 4, and allowing the plurality of users attending the group meeting to exchange various types of information.

When the pattern determining part 133 determines the plurality of patterns, the operation receiving part 131 receives an operation of selecting one of the plurality of patterns from the host terminal 2. The operation receiving part 131 notifies the terminal control part 134 of information indicating the selected pattern. The terminal control part 134 causes each of the plurality of users to attend the group meeting associated with said user in the pattern selected from among the plurality of patterns. By doing this, the meeting management system S can easily switch the allocation of a plurality of users to a plurality of group meetings according to an operation by a host, thereby reducing the time and effort of the host.

Further, the terminal control part 134 may select any one of a plurality of patterns according to the date and time when a plurality of group meetings are executed. In this case, the start date and time is set in advance for each of the plurality of patterns by the host, for example. After the start of the event, the terminal control part 134 selects said pattern when the current time has passed the start date and time of any of the plurality of patterns. The terminal control part 134 causes each of the plurality of users to attend the group meeting associated with said user in the pattern selected from among the plurality of patterns. By doing this, the meeting management system S can automatically switch the allocation of a plurality of users to a plurality of group meetings according to a preset schedule, thereby reducing the time and effort of the host.

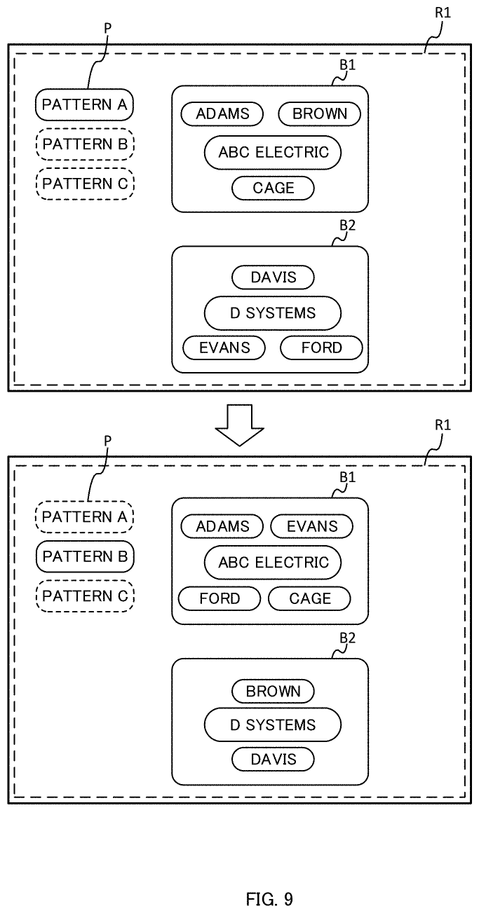

During the event, the terminal control part 134 transmits information indicating statuses of a plurality of group meetings to the host terminal 2 via the communication part 11. FIG. 9 shows an example of an event status screen showing statuses of a plurality of group meetings displayed on the host terminal 2.

An area R1 including a plurality of booths B1 and B2 is displayed on the event status screen, similarly to the screen illustrated in FIG. 2. In each of the booths B1 and B2, the names of the users attending the group meeting are shown.

On the event status screen, pattern information P including one or the plurality of patterns determined by the pattern determining part 133 is displayed. In the pattern information P, the selected pattern and the non-selected pattern are displayed in different display modes. An upper figure of FIG. 9 shows a state in which a pattern A is selected, and a lower figure of FIG. 9 shows a state in which a pattern B is selected. By doing this, the host can grasp the allocation of the plurality of users to the plurality of groups for each pattern in a comprehensive manner by referencing the event status screen.

Further, the terminal control part 134 may cause an exhibitor terminal 3 used by a person in charge attending a group meeting to display information concerning actions of a plurality of users attending said group meeting in an event. In this case, the data acquiring part 132 acquires a visit history indicating a booth (table) that each of the plurality of users attending the group meeting has attended in the event, for example. The terminal control part 134 causes the exhibitor terminal 3 to display information corresponding to the visit history acquired by the data acquiring part 132 as action information concerning actions of the users in the event. The terminal control part 134 may cause the exhibitor terminal 3 to display, as the action information, the visit history itself, or may cause the exhibitor terminal 3 to display the user's field of interest estimated on the basis of the booths included in the visit history.

Further, the terminal control part 134 generates statistical information generated by summarizing action information of the plurality of users attending the group meeting. For example, the terminal control part 134 calculates a ratio of users who are interested in each of a plurality of fields corresponding to a plurality of group meetings included in the event on the basis of the visit history, and generates information in which each of the plurality of fields and the calculated ratio are associated with each other as the statistical information. The terminal control part 134 causes the exhibitor terminal 3 to display the generated statistical information. The terminal control part 134 may cause not only the exhibitor terminal 3, but also the host terminal 2 or the attendee terminal 4, to display the action information and the statistical information.

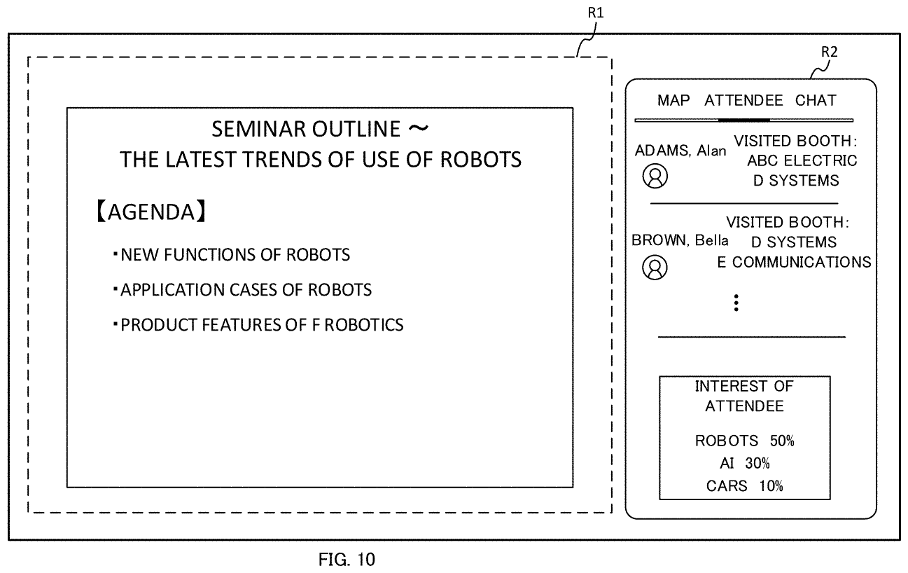

FIG. 10 shows an example of a screen in the group meeting displayed on the exhibitor terminal 3. Similar to the screen shown in FIG. 3, in an area R1 shown in FIG. 10, presentation materials prepared by the exhibitor company are displayed. In an area R2 of FIG. 10, the action information and the statistical information of a plurality of users attending the group meeting are displayed. By doing this, the meeting management system S can notify any user of the information concerning actions of the plurality of users attending the group meeting in the event, and assist with communication between the users.

The operation receiving part 131 may receive, from the attendee terminal 4 or the exhibitor terminal 3, an operation of selecting a destination group meeting (table) from among a plurality of group meetings on condition that the setting to allow the shifting between the tables has been made on the table setup screen of FIG. 6. The operation receiving part 131 notifies the terminal control part 134 of information indicating the selected destination group meeting. The terminal control part 134 causes a user to attend the destination group meeting selected by said user. By doing this, the meeting management system S can shift the user between the tables according to the operation by the user.

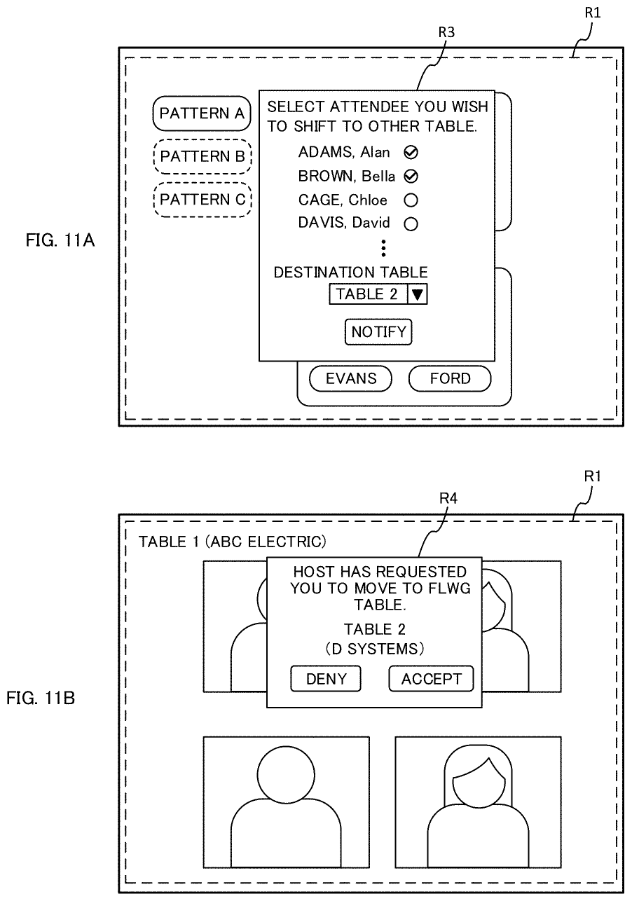

The operation receiving part 131 may receive an operation of selecting (i) one or a plurality of users and (ii) a destination group meeting (table) from the host terminal 2. FIG. 11A shows an example of a screen for shifting a user displayed on the host terminal 2. The operation receiving part 131 notifies the terminal control part 134 of information indicating (i) the one or more users and (ii) the destination group meeting selected on the screen of FIG. 11A.

The terminal control part 134 causes the attendee terminal 4 or the exhibitor terminal 3, used by each of the one or more users being selected, to display information indicating the selected destination group meeting. FIG. 11B shows an example of a screen showing a request for shifting to a destination group meeting displayed on the attendee terminal 4 or the exhibitor terminal 3. Further, the operation receiving part 131 receives, from the attendee terminal 4 or the exhibitor terminal 3, an operation of selecting whether to accept shifting to the destination group meeting on the screen of FIG. 11B.

The terminal control part 134 causes a user to shift to the destination group meeting on condition that said user has performed the operation to accept shifting. By doing this, the meeting management system S can shift a desired user to a desired table according to an operation by a host.

### [Flow of Processing in the Meeting Management Apparatus 1]

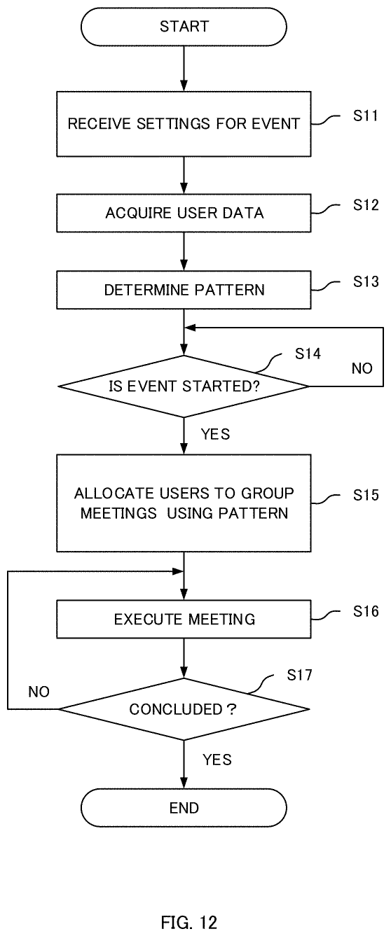

FIG. 12 is a flowchart showing an example of a flow of processing in the meeting management apparatus 1. The operation receiving part 131 receives various settings for an event from the host terminal 2 via the communication part 11 (S11). The operation receiving part 131 receives, from a host, a selection of user data for a plurality of users in the host terminal 2. The data acquiring part 132 acquires the user data selected by the host terminal 2 via the communication part 11 (S12).

The pattern determining part 133 determines a pattern in which each of a plurality of users and any one of a plurality of group meetings are associated with each other on the basis of the user data acquired by the data acquiring part 132 (S13).

The meeting management apparatus 1 stands by until the event starts (NO in S14). When the event is started (YES in S14), the terminal control part 134 causes each of the plurality of users to attend the group meeting associated with said user in the pattern determined by the pattern determining part 133 among the plurality of group meetings. That is, the terminal control part 134 allocates the plurality of users to the plurality of group meetings using the pattern determined by the pattern determining part 133 (S15).

The terminal control part 134 executes the group meeting by relaying sound data based on voice input by the user and text data input by the user, which are transmitted from the exhibitor terminal 3 and the attendee terminal 4, and allowing the plurality of users attending the group meeting to exchange various types of information (S16).

The meeting management apparatus 1 repeats the process of S16 until receiving an instruction to conclude the event from the host terminal 2 (NO in S17), for example. When the meeting management apparatus 1 receives the instruction to conclude the event from the host terminal 2 (YES in S17), the meeting management apparatus 1 ends the process, for example.

### [Effect of the Meeting Management System S]

As described above, the meeting management apparatus 1 determines the pattern in which each of the plurality of users and any one of the plurality of group meetings are associated with each other in advance by acquiring the user data concerning the plurality of users (i.e., attendee and persons in charge) before the start of the event. After the start of the event, the meeting management apparatus 1 causes each of the plurality of users to attend the group meeting associated with said user in the pattern among the plurality of group meetings. As a result, the meeting management apparatus 1 can reduce the time and effort of the host of the event needed to specify the attendees attending each of the plurality of group meetings.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A meeting management apparatus managing a plurality of group meetings that a plurality of users can attend using a communication terminal, the meeting management apparatus comprising:
a data acquiring part that acquires user data concerning the plurality of users before the start of an event including the plurality of group meetings;
a pattern determining part that determines a pattern in which each of the plurality of users and any one of the plurality of group meetings are associated with each other on the basis of the user data; and
a terminal control part that, after the start of the event, causes each of the plurality of users to attend the group meeting associated with the user in the pattern among the plurality of group meetings.

2. The meeting management apparatus according to claim 1, wherein
the pattern determining part determines a plurality of the patterns on the basis of the user data, and
the terminal control part causes each of the plurality of users to attend the group meeting associated with the user in the pattern selected from among the plurality of patterns.

3. The meeting management apparatus according to claim 2, wherein
the terminal control part selects a pattern from among the plurality of patterns in response to an operation in a terminal different from the communication terminal.

4. The meeting management apparatus according to claim 2, wherein
the terminal control part selects a pattern from among the plurality of patterns according to the date and time when the plurality of group meetings are executed.

5. The meeting management apparatus according to claim 1, wherein
the data acquiring part acquires the user data specifying a group meeting which each of the plurality of users attends, and
the pattern determining part determines the pattern in which each of the plurality of users is associated with any one of the plurality of group meetings specified for the user in the user data.

6. The meeting management apparatus according to claim 1, wherein
the data acquiring part acquires the user data including user attributes of each of the plurality of users, and
the pattern determining part determines the pattern in which each of the plurality of users is associated with any one of the plurality of group meetings specified on the basis of the user attributes of the user.

7. The meeting management apparatus according to claim 6, wherein
the pattern determining part determines the pattern in which a first user and a second user are associated with different group meetings among the plurality of group meetings when the user attributes of the first user and the user attributes of the second user satisfy a predetermined relationship.

8. The meeting management apparatus according to claim 6, wherein
the terminal control part causes the host terminal to display an item of the user attributes that should be included in the user data according to a type of the event selected in the host terminal used by a host of the event.

9. The meeting management apparatus according to claim 1, wherein
the terminal control part causes the communication terminal to display action information concerning actions of the plurality of users attending the group meeting in the event.

10. The meeting management apparatus according to claim 9, wherein
the terminal control part causes the communication terminal to display statistical information generated by summarizing the action information of the plurality of users attending the group meeting.

11. A meeting management method, executed by a computer, for managing a plurality of group meetings that a plurality of users can attend using a communication terminal; the meeting management method comprising:
acquiring user data concerning the plurality of users before the start of an event including the plurality of group meetings;
determining a pattern in which each of the plurality of users and any one of the plurality of group meetings are associated with each other on the basis of the user data; and
causing each of the plurality of users to attend the group meeting associated with the user in the pattern among the plurality of group meetings after the start of the event.

12. A computer-readable non-transitory storage medium storing a program for causing a computer to manage a plurality of group meetings that a plurality of users can attend using a communication terminal; the program causing the computer to execute:
acquiring user data concerning the plurality of users before the start of an event including the plurality of group meetings;
determining a pattern in which each of the plurality of users and any one of the plurality of group meetings are associated with each other on the basis of the user data; and
causing each of the plurality of users to attend the group meeting associated with the user in the pattern among the plurality of group meetings after the start of the event.
